(19) United States
(12) Patent Application Publication
(10) Pub. No.: US 2026/0340403 A1
(43) Pub. Date: Oct. 29, 2026

(54) METHOD AND DEVICE FOR PROCESSING DATA ASSOCIATED WITH A RADAR SYSTEM

(71) Applicant: Robert Bosch GmbH, Stuttgart (DE)

(72) Inventors: Aya Mostafa Ahmed, Bochum (DE); Frank Schmidt, Leonberg (DE)

(21) Appl. No.: 19/381,465

(22) Filed: Nov. 6, 2025

(30) Foreign Application Priority Data
Nov. 7, 2024 (DE) 10 2024 210 684.4

(51) Int. Cl. G06N 3/09; G01S 7/02; G06N 3/0455

(52) U.S. Cl. CPC G06N 3/09; G01S 7/023; G06N 3/0455

(57) ABSTRACT

A method for processing data associated with a radar system for a vehicle or an infrastructure device, for reducing interference. In one example, the method includes providing a generative model of the variational autoencoder type, wherein the generative model comprises a first artificial neural network and a second artificial neural network, providing training data comprising several different training data sets for training the generative model, training the first artificial neural network and the second artificial neural network with a first set of the training data, and further training the second artificial neural network with a second set of the training data.

### BACKGROUND

The disclosure relates to a method for processing data associated with a radar system.

The disclosure further relates to a device for processing data associated with a radar system.

### SUMMARY

Some examples relate to a method, for example a computer-implemented method, for processing data associated with a radar system, for example for a vehicle or an infrastructure device, for reducing interference, comprising: providing a generative model of the variational autoencoder type, wherein the generative model comprises a first artificial neural network and a second artificial neural network, providing training data comprising several different training data sets for training the generative model, training the first artificial neural network and the second artificial neural network with a first set of the training data, further training the second artificial neural network with a second set of the training data. In some examples, this enables a more efficient reduction of interference with respect to radar signals of the radar system compared to some conventional approaches, for example.

In some examples, the first artificial neural network is designed to have a first network architecture and is trained to receive a first radar signal, for example in the form of a spectrum, for example in the form of a distance Doppler representation, which may be potentially faulty or interferential, for example as first input data, and to generate, based on the first input data, first output data that characterizes a feature representation r associated with a probability distribution, for example according to r=(μᵣ, σᵣ)=φ_{θ}(S)∈Rⁿ×Rⁿ, wherein trainable parameters, for example weights, represent the first network architecture, wherein μᵣ represents a mean value of the probability distribution, and wherein σᵣ represents a standard deviation of the probability distribution, wherein, for example, the method comprises: receiving the first radar signal, generating, by means of the first artificial neural network, the first output data.

For example, the first artificial neural network has several layers, wherein at least some layers have and/or represent at least one of the following elements: a) linear layer, or b) convolutional layer, or c) nonlinear activation and/or self-attention layer, for example self-attention layer. The same can also apply to the second artificial neural network for other examples.

In some examples, the second artificial neural network has a second network architecture and is designed to generate, based on a sample x drawn from the probability distribution characterized by the mean value μᵣ and standard deviation σᵣ, second output data that characterize a second radar signal, for example in the form of a spectrum, for example in the form of a distance Doppler representation, for example, according to S̅=ψ_{η}(x), wherein, for example, η represents trainable parameters, for example weights, of the second network architecture, wherein, for example, the method comprises: providing the sample x, for example according to

$$x ∼ N ( {μ}_{r} , diag ( {σ}_{r}^{2} ) ) ,$$

generating, by means of the second artificial neural network, the second output data. In further examples, this allows a synthetic radar signal to be generated which, for example, has a lower level of interference than the first radar signal.

In some examples, the training and/or further training involves the use of a fully supervised training method, for example based on at least one non-interferential signal and at least one, for example potentially, interferential signal, for example the first radar signal.

In some examples, training and/or further training involves using a loss function according to

$$L ( S , {S}_{0} ) = \frac{{‖ \tilde{S} - {S}_{0} ‖}^{2}}{2} + λ \cdot {\underbrace{( {‖ {μ}_{r} ‖}^{2} + 〈 {σ}_{r} , 1 〉 - 〈 ln ( {σ}_{r}^{2} ) , 1 〉 - n )}}_{KL} ,$$

wherein L(S, S₀) the loss function is characterized by (μᵣ, σᵣ)=φ_{θ}(S), wherein \tilde{S}=f_{θ,η}(S) an entire non-deterministic network associated with the model is characterized by, wherein, with >0, characterizes a hyperparameter, wherein KL characterizes a Kullback-Leibler divergence according to

$$KL [ N ( {μ}_{r} , diag ( {σ}_{r}^{2} ) ) ‖ N ( 0 , diag ( 1 ) ) ] ,$$

wherein N(0,diag(1)) a predeterminable distribution, for example, a “target distribution,” e.g., a distribution of the feature space for radar signals, wherein, for example, the loss function is adaptable to a predeterminable other target distribution, for example, by replacing N(0,diag(1)) with another, for example, uniform distribution, for example, over an n-dimensional hypercube with edge length 1.

In some examples, the method shows: determining at least one training data set of the training data by means of simulation, for example using a simulation environment, for example determining three different training data sets by means of the simulation, wherein, for example, the different training data sets each have a different complexity, for example with respect to a possible interference.

In some examples, it is envisaged that the method comprises: generating a number, for example a batch, of pairs consisting of a potentially disturbed signal and an undisturbed signal based on the training data, Exchanging, with a predeterminable probability, at least some, for example all, disturbed signals of the number with a respective undisturbed signal, updating trainable parameters of at least one of the two artificial neural networks based on a gradient of, for example, the loss function, wherein the loss function evaluates a match between an output signal of the generative model and an undisturbed signal, and optionally repeating at least one of the aspects a) generating, or b) exchanging, or c) updating, for example repeating until a convergence criterion, for example based on a validation data set, is satisfied, wherein, for example, the training method comprises at least one of the aspects of generating, or b) exchanging, or c) updating, or repeating.

For example, the method has at least one of the following elements: a) initializing parameters, for example weights, of the generative model, or b) training, using the training method and a first training data set, the trainable parameters of the first network architecture and the trainable parameters of the second network architecture, or c) further training, using the training method and a second training data set, the trainable parameters of the first network architecture and the trainable parameters of the second network architecture, or d) further training, using the training method and a third training data set, for example alone, the trainable parameters of the second network architecture.

Further examples relate to a device configured to perform the method according to the disclosure.

Further examples relate to a vehicle comprising at least one device according to the disclosure.

Further examples relate to a device, for example an infrastructure device, for example a road infrastructure device, for example a roadside unit, comprising at least one device according to the disclosure.

Further examples relate to a computer-readable storage medium comprising commands that, when executed by a computer, prompt the latter to perform the method according to the disclosure.

Further examples relate to a computer program comprising commands which, when executed by a computer, cause the computer to perform the method according to the disclosure.

Further examples relate to a data carrier signal that transmits and/or characterizes the computer program according to the disclosure.

Further examples relate to the use of the method according to the disclosure and/or the device according to the disclosure and/or the vehicle according to the disclosure and/or the apparatus according to the disclosure and/or the computer-readable storage medium according to the disclosure and/or the computer program according to the disclosure and/or the data carrier signal according to the disclosure for at least one of the following elements: a) operating a radar system, for example for a vehicle and/or for a, for example stationary, device, or b) reducing interference, for example interference healing, or c) increasing the efficiency of training, or d) reducing the amount of information required for training.

Further features, possible applications, and advantages are apparent from the following description of examples shown in the figures of the drawing. All described or depicted features by themselves or in any combination constitute the subject matter of the disclosure, regardless of their combination in the claims or their reference to other claims and regardless of their wording or representation in the description or in the drawings.

### BRIEF DESCRIPTION OF THE DRAWINGS

The drawings show:

FIG. 1 a schematic illustration of a simplified flowchart,

FIG. 2 a schematic illustration of a simplified block diagram,

FIG. 3 a schematic illustration of a simplified flowchart,

FIG. 4 a schematic illustration of a simplified flowchart,

FIG. 5 a schematic illustration of a simplified flowchart,

FIG. 6 a schematic illustration of a simplified flowchart,

FIG. 7 a schematic illustration of a simplified flowchart,

FIG. 8 a schematic illustration of a simplified block diagram,

FIG. 9 schematic examples of uses.

### DETAILED DESCRIPTION

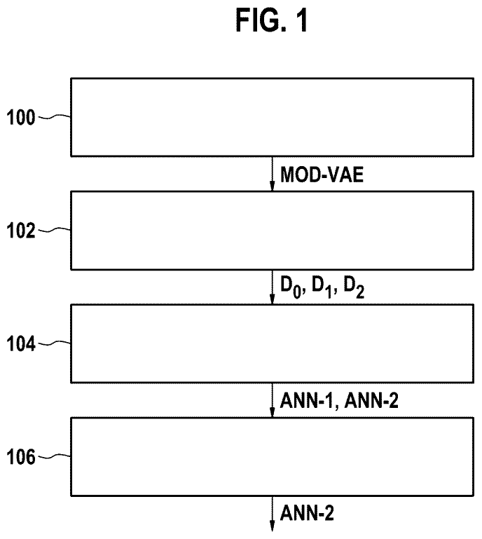

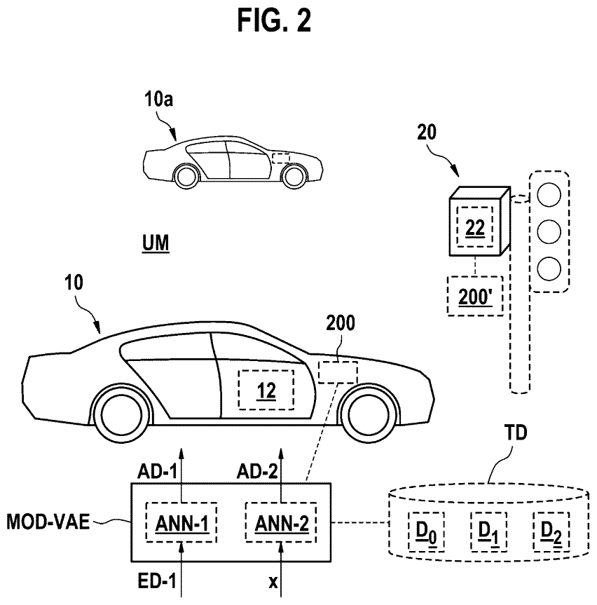

Some examples, see e.g. FIGS. 1, 2, relate to a method, for example a computer-implemented method, for processing data associated with a radar system 12, 22 (FIG. 2), for example for a vehicle 10 or an infrastructure device 20, for reducing interference, comprising: providing 100 (FIG. 1) a generative model MOD-VAE of the variational autoencoder type, wherein the generative model MOD-VAE comprises a first artificial neural network ANN-1 and a second artificial neural network ANN-2, providing 102 several different training data sets D₀, D₁, D₂ for training the generative model MOD-VAE, training 104 the first artificial neural network ANN-1 and the second artificial neural network ANN-2 with a first set D₁, D₂ of the training data TD, further training 106, for example after training 104, the second artificial neural network ANN-2, for example only the second artificial neural network ANN-2, with a second set D₀ of the training data TD. In some examples, this enables a more efficient reduction of interference with respect to radar signals of the radar system 12, 22 compared to some conventional approaches, for example.

In some examples, FIG. 2, the radar system 12 may be, for example, an automotive radar system 12 for use in vehicles 10, 10a, for example for detecting objects such as other vehicles 10a and/or obstacles in an environment UM of the vehicle 10.

A VAE (variational autoencoder) model is a generative model that can combine the properties of an autoencoder with probabilistic modeling. In some examples, a VAE consists of two parts: an encoder, which transforms input data into a comparatively low-dimensional latent representation described as a probability distribution, and a decoder, which reconstructs the original data from the latent representation, for example. In some examples, a VAE model can be used to generate new data that is similar to the training data, for example. In the present case, the generative model MOD-VAE is used to remove unwanted interference from a radar signal received, for example, by means of the radar system 12, 22 (FIG. 2), for example in the context of so-called “interference healing”, whereby a subsequent evaluation of the interference-reduced radar signal can be improved.

In some examples, FIG. 2, at least some aspects of the method according to the disclosure can be performed by a device 200, 200′ which, for example, can be associated with a respective radar system 12, 22, for example integrated therein (not shown).

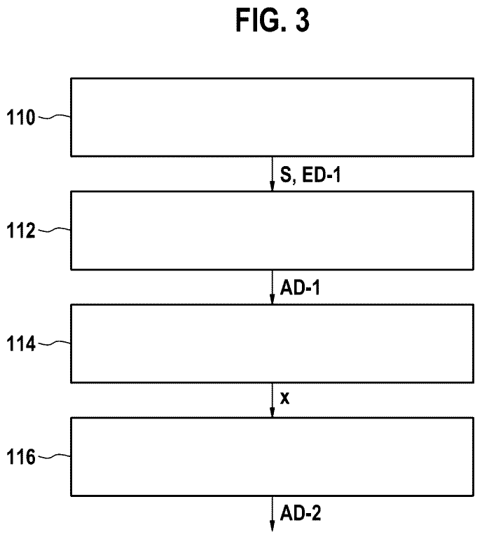

In some examples, FIGS. 2 and 3, it is envisaged that the first artificial neural network ANN-1 has a first network architecture and is designed to receive a first radar signal S (e.g., received from the radar system 12), which may be potentially faulty or interferential, for example in the form of a spectrum, for example in the form of a distance Doppler representation, for example as first input data ED-1, 110 and, based on the first input data ED-1, to generate first output data AD-1 which characterizes a feature representation r associated with a probability distribution, for example according to r=(μᵣ, σᵣ)=φ_{θ}(S)∈Rⁿ×Rⁿ, wherein trainable parameters, for example weights, represent the first network architecture, wherein μᵣ represents a mean value of the probability distribution, and wherein of represents a standard deviation of the probability distribution. In other words, the process may exhibit the following in some examples, FIG. 3: receiving 110 the first radar signal S, generating 112, by means of the first artificial neural network ANN-1, the first output data AD-1.

For example, FIG. 2, the first artificial neural network ANN-1 has several layers, wherein at least some layers have and/or represent at least one of the following elements: a) linear layer, or b) convolutional layer, or c) nonlinear activation and/or self-attention layer, for example, self-attention layer. The same can also apply to the second artificial neural network ANN-2 for other examples. In general, different combinations of the above layers are possible in some examples to realize the first and second network architecture.

In some examples, FIGS. 2 and 3, the second artificial neural network ANN-2 has a second network architecture and is designed to generate, based on a sample x drawn from the probability distribution characterized by the mean value μᵣ and standard deviation σᵣ, second output data AD-2 that characterize a second radar signal S, for example in the form of a spectrum, for example in the form of a distance Doppler representation, for example, according to \tilde{S}=ψₙ(x), wherein, for example, η represents trainable parameters, for example weights, of the second network architecture. In other words, in some examples, FIG. 3, the method may have: providing 114 the sample x, for example according to

$$x ∼ N ( {μ}_{r} , diag ( {σ}_{r}^{2} ) ) ,$$

generating 116, by means of the second artificial neural network ANN-2, the second output data AD-2. In this way, in further examples, a synthetic S radar signal can be generated which, for example, has a lower level of interference than the first radar signal, but which, for example, has a comparable information content in terms of useful radar signal information, e.g. for object detection.

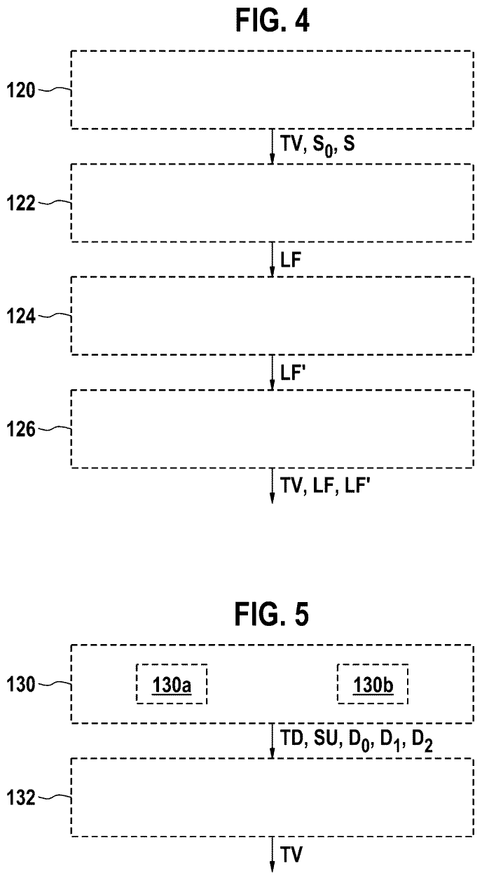

In some examples, FIG. 4, training 104 (FIG. 1) and/or further training 106 involves using 120 (FIG. 4) a fully supervised training method TV, for example based on at least one non-interferential signal (or radar signal) S₀ and at least one, for example potentially, interferential signal, for example the first radar signal S.

In some examples, FIG. 4, training 104 (FIG. 1) and/or further training 106 involves using 122 a loss function LF according to

$$L ( S , {S}_{0} ) = \frac{{‖ \tilde{S} - {S}_{0} ‖}^{2}}{2} + λ \cdot {\underbrace{( {‖ {μ}_{r} ‖}^{2} + 〈 {σ}_{r} , 1 〉 - 〈 ln ( {σ}_{r}^{2} ) , 1 〉 - n )}}_{KL} ,$$

wherein L(S, S₀) the loss function is characterized by (μᵣ, σᵣ)=φ_{θ}(S) wherein \tilde{S}=f_{θ,η}(S) an entire non-deterministic network associated with the model MOD-VAE (FIG. 2) is characterized by, wherein, with >0, characterizes a hyperparameter, wherein KL characterizes a Kullback-Leibler divergence according to

$$KL [ N ( {μ}_{r} , diag ( {σ}_{r}^{2} ) ) ‖ N ( 0 , diag ( 1 ) ) ] ,$$

wherein N(0,diag(1)) a predeterminable distribution, for example, a “target distribution,” e.g., a distribution of the feature space for radar signals, wherein, for example, the loss function is adaptable to a predeterminable other target distribution, see the optional block 124 according to FIG. 4, for example, by replacing N(0,diag(1)) with another, for example, uniform distribution, for example over an n-dimensional hypercube with edge length 1, which can lead to an adapted loss function LF′.

The optional block 126 according to FIG. 4 symbolizes an optional execution of the training method TV for the model MOD-VAE, for example for at least one of its nets ANN-1, ANN-2, using the loss function LF or the adapted loss function LF′.

In some examples, FIG. 5, the method shows: determining 130 at least one training data set D₁, D₂ of the training data TD (FIG. 2 by means of simulation, for example using 130a a simulation environment SU, for example determining 130b three different training data sets D₀, D₁, D₂ by means of the simulation, wherein, for example, the different training data sets D₀, D₁, D₂ each have a different complexity, for example with respect to a possible interference. The optional block 132 according to FIG. 5 symbolizes an optional execution of the training method TV based on the respective training data sets.

Further examples and aspects relating to the determination of the training data TD are described below. For example, the simulation environment SU (FIG. 5) can be used to place various devices, e.g. vehicles 10, 10a, in a complex environment UM (FIG. 2), and both clean signals (i.e. signals with no interference) and disturbed signals (i.e. signals with non-vanishing interference), i.e. radar signals, can be determined, e.g. recorded.

In some examples, a clean (interference-free) signal can be determined, e.g. recorded, in two different ways: 1. Deactivation of the radar units or radar systems of all interfering vehicles 10a, or 2. as in aspect 1 above, but plus ignoring the effects of clutter and multipath effects (e.g. directly in a simulation).

In some examples, at least two different data sets, e.g. ₁ and ₂, can be created using the approaches described above.

In some examples, an additional data set ₀ is created that uses or replicates real data, for example. In some examples, for example, two types of signals can be taken into account: 1. Each vehicle 10, 10a uses the same central frequency, for example center frequency, e.g. in odd cycles, 2. Each vehicle 10, 10a uses a different central frequency or center frequency (e.g. in even cycles). For example, since in some examples a road scenario is pre-planned for determining the data sets, a frequency plan can be executed with precisely synchronized timing, whereby usable data sets can be obtained for efficient training 104, 106 (FIG. 1). For example, with the approach described above, clean (interference-free) signals can be obtained with even cycles and disturbed (interferential) signals with odd cycles.

In some examples, the training data TD can be organized or provided e.g. in the form of three data sets, e.g. with increasing complexity: −₂ is the simplest data set, −₁ is more complex, e.g. due to self-interference, −₀ is even more complex, e.g. because the clean and disturbed signals may have a small time delay.

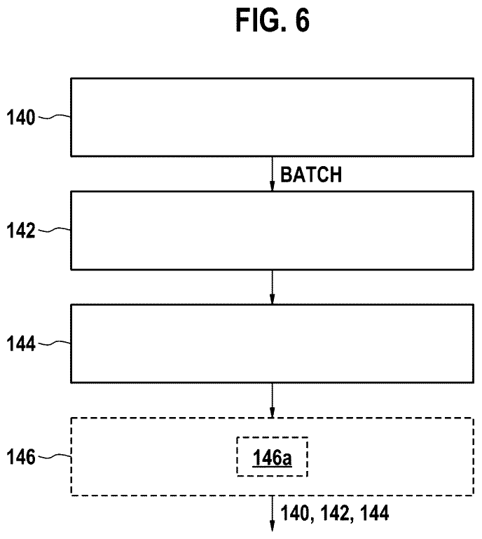

In some examples, FIG. 6, it is envisaged that the method comprises: generating 140 a number, for example a batch, BATCH of pairs consisting of a potentially disturbed signal, for example a radar signal, and an undisturbed signal, for example a radar signal, based on the training data TD, Exchanging 142, with a predeterminable probability p, at least some, for example all, disturbed signals of the number BATCH with a respective undisturbed signal, Updating 144 trainable parameters n of at least one of the two artificial neural networks ANN-1, ANN-2 based on a gradient of, for example, the loss function LF (FIG. 4), wherein the loss function LF evaluates a match between an output signal of the generative model MOD-VAE and an undisturbed signal, and optionally repeating 146 (FIG. 6) at least one of the aspects a) generating 140, or b) replacing 142, or c) updating 144, for example repeating 146a until a convergence criterion, for example based on a validation data set, is satisfied, wherein, for example, the training method TV has at least one of the aspects generating 140, or b) replacing 142, or c) updating 144, or repeating 146, 146a.

In some examples, probability-dependent replacement, such as replacing 142 the corrupted signal with the clean signal (FIG. 6), serves to enable the MOD-VAE model to learn features that are not focused on the corruption but rather on the underlying clean signal, for example.

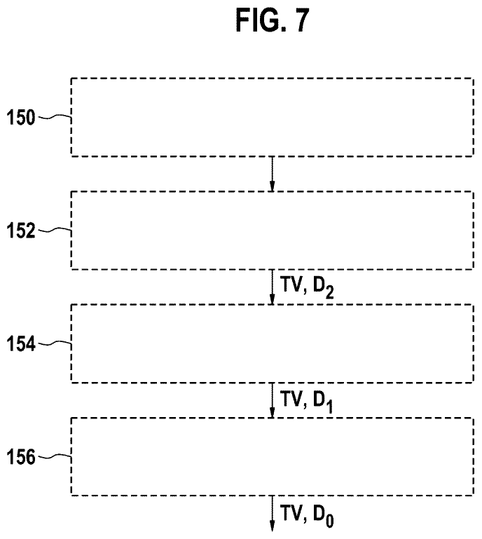

For example, FIG. 7 shows that the method has at least one of the following elements: a) initializing 150 parameters, for example weights, n of the generative model MOD-VAE, or b) training 152, using the training method TV (see, for example, FIG. 6) and a first training data set 2, the trainable parameters of the first network architecture and the trainable parameters of the second network architecture, or c) further training 154, using the training method TV and a second training data set 1, the trainable parameters of the first network architecture and the trainable parameters of the second network architecture, or d) further training 156, using the training method TV and a third training data set ₀, for example alone, the trainable parameters of the second network architecture.

In other words, a training with the three training data sets D₀, D₁, D₂ can be comparatively similar, for example, each using the sequence according to FIG. 6, whereby, for example, the respective training data sets D₀, D₁, D₂ are each different from one another, as described above.

In some examples, FIG. 7, it is important that only the second network ANN-2 is trained in block 156, but not, for example, the first network ANN-1. This helps in some examples to use the same features as in the simulation, since these are ideal features, for example. For example, only the interpretation of these features will improve on the basis of the new real data.

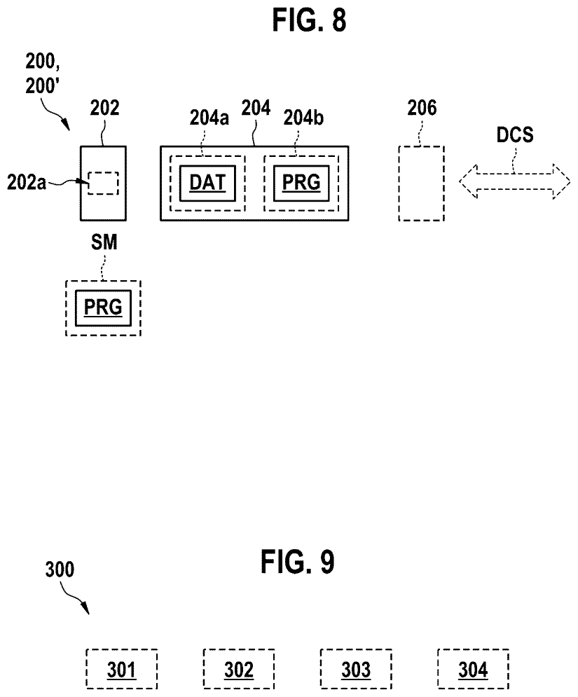

Further examples, FIG. 8, relate to a device 200, 200′ configured to perform the method according to the disclosure. For example, the device 200, 200′ can be used for at least one vehicle 10, 10a or its radar system 12 and/or for at least one, for example stationary, device 20, such as a roadside unit, or its radar system 22.

In some examples, FIG. 8, it is provided that the device 200, 200′ comprises: a computing device (“computer”) 202 comprising at least one computer 202a, a memory device 204 associated with the computing device 202 for at least temporarily storing at least one of the following elements: a) data DAT (e.g. information associated with the generative model MOD-VAE and/or the training method TV therefor, for example data TD), b) computer program PRG, for example for executing the method according to the disclosure.

In further examples, FIG. 8, the storage device 204 has a volatile memory (e.g., random access memory (RAM)) 204a and/or a non-volatile (NVM) memory (e.g., flash EEPROM) 204b, or a combination thereof or with other memory types not explicitly mentioned.

Further examples, FIG. 8, relate to a computer-readable storage medium SM comprising commands PRG that, when executed by a computer 202, prompt the latter to perform the method according to the disclosure.

Further examples, FIG. 8, relate to a computer program PRG comprising commands which, when executed by a computer 202, cause the computer to perform the method according to the disclosure.

Further examples, FIG. 8, relate to a data carrier signal DCS that characterizes and/or transmits the computer program PRG in accordance with the disclosure. The data carrier signal DCS can, for example, be transmitted (e.g., sent and/or received) via an optional data interface 206 of the device 200, 200′.

Further examples, FIG. 2, relate to a vehicle 10 comprising at least one device 200 according to the disclosure.

Further examples, FIG. 2, relate to a device 20, for example an infrastructure device, for example a road infrastructure device, for example a roadside unit, comprising at least one device 200′ according to the disclosure.

Further aspects and examples are described below, which—in the case of further examples—can each be combined individually or in any combination with one another with at least one of the aspects and/or examples described above.

The principle according to the disclosure can be advantageously used for reducing or “healing” interference, e.g., from received radar signals (e.g., “signal healing”). Radar, for example, is an important sensor for solving perception tasks, such as for vehicles 10, 10a (FIG. 2), e.g. for autonomous driving. In addition, radar can be used, for example, to control the beam shaping of a communication base station (not shown), for example by incorporating knowledge from the environment UM (FIG. 2), e.g. detectable by means of at least one radar system 12, 22.

In some examples, signal healing may involve estimating a clean signal by removing aspects of the signal to be healed that originate from other transmitters or other sources of interference, for example. In some examples, the generative model MOD-VAE (FIG. 1, 2) can be used for this purpose, whose networks ANN-1, ANN-2 can be trained in other examples as described above. Signal healing according to the disclosure is useful because in real-life scenarios, for example, interference can never be completely avoided.

The use of the generative model MOD-VAE of the VAE type makes it possible to create comparatively meaningful features for some examples, for example for signal healing. Furthermore, the principle according to the disclosure enables a combination of several training stages, e.g. in the sense of a preliminary training (see e.g. blocks 152, 154 according to FIG. 7) and a subsequent fine-tuning (see e.g. block 156 according to FIG. 7).

In some examples, aspects of the MOD-VAE generative model can be trained in advance with simulation data, e.g., obtained using the SU simulation environment (FIG. 5), which can be used to generate comparatively demanding urban scenarios with various multiple disturbances. In some examples, e.g. after pre-training 152, 154, only the second part ANN-2 of the model or network MOD-VAU can be used, e.g. for fine-tuning with real data, for further training. This reduces data requirements, e.g. real data, in some examples, e.g. without having to adapt the MOD-VAE model to a potentially smaller data set of real data.

The principle according to the disclosure generates comparatively meaningful representations and reduces, for example, overfitting. Thus, the approach according to the disclosure is comparatively well adapted to the real-world problem of radar interference and can, for example, produce a purer signal than some conventional approaches. This helps, for example, with perception tasks (e.g. recognizing objects or road users), which can increase road safety.

In general, the principle according to the disclosure can also be applied, for example, to image analysis (e.g. digital images, video, radar, lidar, ultrasound, motion, thermal imaging) or video analysis or audio analysis and is not limited to radar signals.

Further examples, FIG. 9, relate to a use 300 of the method according to the disclosure and/or the device 200, 200′ according to the disclosure and/or the vehicle 10 according to the disclosure and/or the device 20 according to the disclosure and/or the computer-readable storage medium SM according to the disclosure and/or the computer program PRG according to the disclosure and/or the data carrier signal DCS according to the disclosure for at least one of the following elements: a) operating 301 a radar system 12, 22, for example for a vehicle 10 and/or for a, for example stationary, device 20, or b) reducing 302 interference, for example interference healing, or c) increasing 303 the efficiency of training 104, 106, or d) Reducing 304 the amount of information required for training, for example real data.

1. A computer-implemented method for processing radar system (12, 22) data and for reducing interference, the method comprising:
providing (100) a generative model (MOD-VAE) of a variational autoencoder type, wherein the generative model (MOD-VAE) comprises a first artificial neural network (ANN-1) and a second artificial neural network (ANN-2), providing (102) several different training data sets (D₀, D₁, D₂) for training the generative model (MOD-VAE), training (104) the first artificial neural network (ANN-1) and the second artificial neural network (ANN-2) with a first set (D₁, D₂) of the training data (TD), further training (106) the second artificial neural network (ANN-2) with a second set (D₀) of the training data (TD).

2. The method according to claim 1, wherein the first artificial neural network (ANN-1) has a first network architecture and is configured to receive a first radar signal comprising a potentially faulty or interferential signal(S) in the form of a spectrum as first input data (ED-1)) and, based on the first input data (ED-1), to generate first output data (AD-1) that characterize a feature representation associated with a probability distribution, r according to, r=(μᵣ, σᵣ)=φ_{θ}(S)∈Rⁿ×Rⁿ, wherein trainable parameters, for example weights, represent the first network architecture, wherein represents a mean value of the probability distribution and μᵣ wherein represents a standard deviation of the probability distribution, θᵣ wherein the method comprises: receiving (110) the first radar signal and generating (112), by means of the first artificial neural network (ANN-1), the first output data (AD-1).

3. The method according to claim 2, wherein the first artificial neural network (ANN-1) has several layers, wherein at least some layers have and/or represent at least one of the following elements: a) linear layer, or b) convolutional layer, or c) nonlinear activation and/or self-attention layer.

4. The method according to claim 2, wherein the second artificial neural network (ANN-2) has a second network architecture training data sets D₀, D₁, D₂ and is configured to generate, based on a sample x drawn from the probability distribution characterized by the mean value μᵣ and the standard deviation σᵣ, second output data (AD-2) that characterizes a second radar signal (\tilde{S}), in the form of a spectrum, according to \tilde{S}=ψ_{η}(x), wherein, for example, n represents trainable parameters, for example weights, of the second network architecture, wherein, for example, the method comprises: providing (114) the sample x, for example according to
$$x ∼ N ( {μ}_{r} , diag ( {σ}_{r}^{2} ) ) ,$$
generating (116), by means of the second artificial neural network (ANN-2), the second output data (AD-2).

5. The method according to claim 1, wherein the training (104) and/or the further training (106) comprises using (120) a fully supervised training method, training method (TV) based on a non-interferential signal S₀( ), and an interferential signal.

6. The method according to claim 1, wherein the training (104) and/or further training (106) comprises using (122) a loss function (LF) according to
$$L ( S , {S}_{0} ) = \frac{{‖ \tilde{S} - {S}_{0} ‖}^{2}}{2} + λ \cdot {\underbrace{( {‖ {μ}_{r} ‖}^{2} + 〈 {σ}_{r} , 1 〉 - 〈 ln ( {σ}_{r}^{2} ) , 1 〉 - n )}}_{KL} ,$$
wherein L(S, S₀) the loss function (LF) is characterized by (μᵣ, σᵣ)=φ_{θ}(S), wherein \tilde{S}=f_{θ,η}(S) an entire non-deterministic network associated with the model (MOD-VAE) is characterized by, where >0 characterizes a hyperparameter, where KL characterizes a Kullback-Leibler divergence according to KL[N(μᵣ,diag(σᵣ²))∥N(0,diag(1))], wherein N(0,diag(1)) includes a predeterminable distribution, wherein, the loss function (LF) is adaptable (124) to a predeterminable other target distribution by replacing (0,diag(1)) with another distribution over a dimensional hypercube with edge length 1.

7. The method according to claim 1, comprising: determining (130) a training data set (D₁, D₂) of the training data (TD) by means of simulation, and determining (130b) three different training data sets (D₀, D₁, D₂) by means of the simulation, wherein, for example, the different training data sets (D₀, D₁, D₂) each have a different complexity.

8. The method according to claim 1, comprising: generating (140) a number of pairs consisting of a potentially disturbed signal and an undisturbed signal based on the training data (TD), exchanging (142), with a predeterminable probability, at least some, for example all, disturbed signals of the number of pairs with a respective undisturbed signal, updating (144) trainable parameters of at least one of the two artificial neural networks (ANN-1, ANN-2) based on a gradient of a loss function (LF), wherein the loss function (LF) evaluates a match between an output signal of the generative model (MOD-VAE) and an undisturbed signal, and repeating (146) at least one of the aspects a) generating (140), or b) replacing (142), or c) updating (144) until a convergence criterion is satisfied, wherein, the training method (TV) has at least one of the aspects generating (140), or b) replacing (142), or c) updating (144), or repeating (146a).

9. The method according to claim 8, comprising at least one of the following elements: a) initializing (150) parameters of the generative model (MOD-VAE), or b) training (152), using the training method (TV) and a first training data set (₂), trainable parameters of a first network architecture and the trainable parameters of a second network architecture, or c) further training (154), using the training method (TV) and a second training data set (₁), the trainable parameters of the first network architecture and the trainable parameters of the second network architecture, or d) further training (156), using the training method (TV) and a third training data set (₀), for example alone, of the trainable parameters of the second network architecture.

10. A device (200; 200′) configured to perform the method according to claim 1.

11. A vehicle (10) comprising a device (200) according to claim 10.

12. A device (20), for example an infrastructure device, for example a road infrastructure device, for example a roadside unit, comprising a device (200′) according to claim 10.

13. A non-transitory computer-readable storage medium (SM) comprising commands (PRG) which, when executed by a computer (202), prompt the computer (202) to perform the method according to claim 1.
